(19) United States
(12) Patent Application Publication
(10) Pub. No.: US 2026/0295461 A1
(43) Pub. Date: Oct. 1, 2026

(54) CHROMATOGRAPHY COLUMN

(71) Applicant: ASTREA UK SERVICES LIMITED, Cambridge (GB)

(72) Inventors: Geoffrey Neil PARNELL, Stroud (GB); Nicola Jane DICKSON, North Nibley (GB)

(21) Appl. No.: 19/481,809

(22) PCT Filed: May 5, 2023
(86) PCT No.: PCT/GB2023/051209

§ 371 Date: Nov. 5, 2025

(51) Int. Cl. B01D 15/22; G01N 30/60

(52) U.S. Cl. CPC B01D 15/222; G01N 30/6026; G01N 30/606

(57) ABSTRACT

A chromatography column comprises a column tube, a column base assembly, a column header assembly and an interface assembly or insert, wherein the tube, header assembly and base assembly define a process chamber for containing a process liquid. The tube comprises an inner surface and an outer surface and the column base assembly comprises a flow cell and an annular flange. The interface assembly is disposed between the flange and the outer surface of tube and is arranged to create a fluid-impermeable barrier between the process chamber and the flange. The interface assembly comprises a material different from at least that of the flange. The interface assembly may comprise a barrier member. The barrier member may comprise or consist of plastics material. The header assembly may comprise an upper flow cell inlet adaptor for introducing a liquid into the process chamber and an inlet liner for lining an inside surface of the upper flow cell inlet adaptor. The inlet liner may be removable from the upper flow cell inlet adaptor, which may comprise metal. The inlet liner may comprise plastics material. Also claimed is a kit of parts for replacing process-wetted components and other disposable parts includes a replacement interface assembly and inlet liner.

This application relates to a chromatography column and a kit of parts. More specifically, the application relates to a chromatography column with replaceable parts that comprise material that is different from the material of non-replaceable parts of the column, and a corresponding kit of parts for refreshing or refurbishing a chromatography column.

### BACKGROUND

Chromatography is a well-known technique for the separation or measurement of chemical mixtures. Low pressure liquid chromatography (LPLC) may be used in bioprocessing applications, biopharmaceutical production and the development of gene therapies and vaccines. Non-continuous and continuous chromatography applications include, for example, ion exchange chromatography, hydrophobic interaction chromatography, gel filtration and affinity chromatography.

Chromatography relies on chromatography media, which forms the stationary phase of chromatography processes, the media comprising particles or resin packed into a chromatography column. A sample for separation using chromatography is introduced into the top of the column and flushed through the column and stationary phase with a liquid forming the mobile phase, under gravity or pressure. Separation success is achieved by packing the media using clearly defined methods to obtain efficient and sufficient exposure between the sample and the media to bring about separation.

The flow of liquid through the column produces a hydrodynamic pressure drop, and back pressure and flow resistance may be created by increased viscosity of the liquid, chemical interactions and/or frictional forces between the liquid, the components within the liquid (including the sample) and the contents and surfaces of the column.

Over recent years, the pharmaceutical industry has continued to move away from central, in-house production methods and towards the outsourcing of production using single source providers or contract manufacturing organisations (CMO). As a result, CMOs are increasingly purchasing equipment, or consumables therefor, which is disposable (or “single-use”), to be used specifically for and only for a single run or production campaign.

CMOs may purchase chromatography columns for production of a specific product, with the columns being dedicated to that process. If a column is to be used again for a new production batch, it must undergo extensive cleaning; furthermore, if the column is to be used again for a new production campaign, the extent of the cleaning, decontamination and validation required to certify that the equipment poses zero risk for cross contamination means that it may not be commercially viable to reuse such columns.

In a CMO model, it may be preferable to have a production area that can be used for several different campaigns, which can minimise turnaround times and limit unused production space. In such an environment, it is beneficial to have equipment that can be swapped out easily and efficiently, which is disposable, or which offers a ‘plug-and-play’process.

While the cost of the chromatography columns may represent only a fraction of production costs when smaller columns are used, these costs increase significantly as column diameters increase.

Chromatography columns may have an adjustable or fixed bed height and may be supplied empty or pre-packed with chromatography media. Common to each type of column is that as the column diameter increases, the pressure due to hydrostatic and hydrodynamic flow increases the load force on the column components. Traditional column designs direct the load force through end plates, which may comprise flow cells and/or end flanges, and the construction materials chosen for these parts must withstand such forces.

For columns with a smaller diameter, such as those that are less than around 250 mm in diameter, and/or those utilising lower operating pressures, the column components can be made entirely of plastics material. However, as column diameters and/or operating pressures increase, it becomes necessary to increase the thicknesses of any components comprising plastics material; however, as thick sheets of plastics material are limited by their commercial availability, it becomes necessary to select alternatives to plastics material or to use a combination of materials. This is often the case when a chromatography process developed using laboratory-scale components is scaled up for commercial production.

When it is no longer feasible to use only plastics material due to the column dimensions, e.g. diameter, and/or operating pressure requirements (based on operating conditions or specified chromatography media material), stainless steel backing plates may be used to reinforce the plastics material components. As dimensions or operating pressures increase still further, stainless steel may be used for the major column components, such as column tube flanges, increasing costs and manufacturing times.

During a chromatography process, the components which come into contact with process fluids and/or chromatography media become contaminated, meaning that cleaning and decontamination of such components is required before the column can be used for another process. This cleaning and decontamination process can be costly, time-consuming and inconvenient. Furthermore, it may be necessary to obtain additional or ‘spare’ chromatography columns to avoid any down time in processing while already-used chromatography columns are being cleaned and decontaminated, leading to further costs and an increase in the storage space that must be allocated for storing the additional columns. The extensive cleaning and validation procedures required during decontamination means that the alternative of disposing of and replacing components becomes a consideration.

In smaller columns made of plastics material, it is known to replace the plastic components forming the process-wetted flow path. This effectively refreshes or refurbishes the column to a new condition in an economically viable way through the use of replacement components or a refresh or refurbishment kit. However, at greater scales, when the flow path comprises metal parts such as stainless steel, the cost of a such kits is less viable economically.

In addition to the aforementioned problems, it can be undesirable to utilise a flow path containing any components comprising metal such as stainless steel (the most commonly-used example being 316 stainless steel), which is vulnerable to corrosion if subjected to, for example, a high concentration of chloride ions or acidic or other oxidising conditions during the chromatography process. This can limit not only the choice of suitable process liquids or operating conditions for the chromatography process, but also the types of cleaning and sanitising liquids and protocols used once the column has been used. Stainless steel contact can lead to inactivation or denaturation of biological molecules or the formation of a biofilm leading to a risk of further contamination or inactivation of the product to which the chromatography process is applied. All these factors may lead to a decrease in column efficiency and/or decreased product yields. While it may be possible to use other alloys of steel (such as those comprising a higher percentage of molybdenum) to increase corrosion resistance and avoid such reactions, this again can increase the cost and availability of components. These disadvantages may be of particular relevance in a CMO model.

It is an object of the present invention to alleviate the abovementioned disadvantages of the prior art by providing a chromatography column that can maintain the operating envelope of columns comprising metal (such as stainless steel) components while providing a flow path which is free of such metal and which can be refurbished or refreshed in an efficient and economically viable way using a kit of parts.

### SUMMARY OF INVENTION

According to a first aspect of the invention there is provided a chromatography column comprising:
a column tube;
a column base assembly;
a column header assembly; and
an interface assembly;
wherein the tube, base assembly and header assembly define a process chamber for containing a process liquid;
the tube comprises an inner surface and an outer surface;
the column base assembly comprises a flow cell and an annular flange; and
the interface assembly is disposed between the flange and the outer surface of the tube and is arranged to create a fluid-impermeable barrier between the process chamber and the flange;
wherein the interface assembly comprises a material different from at least that of the flange.

The interface assembly is arranged to create a barrier or shield between the process chamber and the flange.

The interface assembly may comprise an annular barrier member.

The barrier member may comprise a plastics material, or may consist of a plastics material, and may comprise an S-shaped cross-section.

The tube may comprise a plastics material. The tube may comprise a transparent material, optionally acrylic material or glass.

The base assembly may comprise a lower flow cell and may comprise a lower bed support.

The flange may comprise or consist of metal material, optionally stainless steel.

The header assembly may comprise an upper flow cell inlet adaptor for introducing a liquid into the process chamber and an inlet liner for lining an inside surface of the upper flow cell inlet adaptor. The inlet liner may be removeable from the upper flow cell inlet adaptor, which may comprise metal. The inlet liner may comprise plastics material, or may consist of plastics material, optionally polypropylene.

The column tube has an external diameter in the range of 300-1600 mm, preferably 400-1200 mm, more preferably 450-900 mm and even more preferably 500-800 mm. The column tube comprises a wall thickness in the range of 5-30 mm, preferably 10-25 mm and more preferably 15-25 mm.

According to a second aspect of the invention there is provided a kit of replacement parts for refurbishing a chromatography column wherein the column comprises, in its operational state, a column tube, a column base assembly, a column header assembly and an interface assembly, the tube, base assembly and header assembly define a process chamber for containing a process liquid, the tube comprises an inner surface and an outer surface, the base assembly comprises a flow cell and an annular flange, the interface assembly is disposed between the flange and the outer surface of the tube and is arranged to create a fluid impermeable barrier between the process chamber and the flange,, an upper flow cell inlet adaptor for introducing a liquid into the process chamber and an inlet liner for lining an inside surface of the upper flow cell inlet adaptor, wherein the interface assembly comprises a material different from at least that of the flange,
wherein the kit of parts comprises:
an interface assembly, the interface assembly comprising a material different from at least that of the flange; and
an inlet liner for lining an inside surface of the upper flow cell inlet adaptor. The kit of parts may comprise all of the components that are process wetted, i.e. those that come into contact with the process fluids during the chromatography process.

The interface assembly may comprise a barrier member.

The barrier member may comprise plastics material, and may consist of plastics material. The barrier member may have an internal diameter in the range of 300-1600 mm, preferably 400-1200 mm, more preferably 450-900 mm, and even more preferably 500-800 mm and may be the same or substantially the same as the external diameter of the column tube. The external diameter of the ring may be at least an additional 55 mm greater than the external diameter of the column tube.

The inlet liner may comprise a plastics material, and may consist of a plastics material.

The kit of parts may comprise a column tube, a flow tube adaptor, a flow tube, an upper flow cell, an upper flow cell inlet adaptor, an upper bed support, a lower bed support and a lower flow cell.

The kit of parts may comprise at least one sealing member, which may be an O-ring.

The kit of parts may comprise a lower flow cell inlet gasket, a lower flow cell inlet adaptor, a lower flow tube seal, a lower blanking cap, a lower pipe clamp, a lower bed support retaining bolt, an upper bed support retaining bolt, a lock nut, an upper flow cell inlet gasket, a first upper flow tube seal, a second upper flow tube seal, an upper blanking cap, an upper pipe clamp and an upper flow cell inlet.

The components of the kit of parts may be disposable and/or recyclable.

### BRIEF DESCRIPTION OF DRAWINGS

FIG. 1a is a cross section of a chromatography column according to an embodiment of the invention.

FIG. 1b is an enlarged portion of FIG. 1a showing the upper flow cell inlet adaptor.

FIG. 1c is an enlarged portion of FIG. 1a showing the base flange and interface assembly.

### DETAILED DESCRIPTION

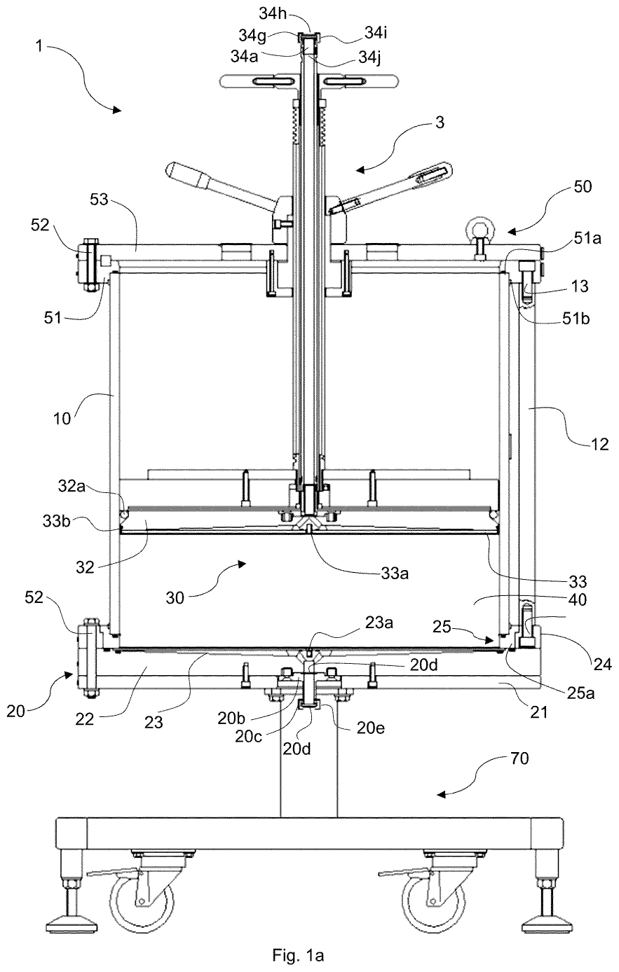

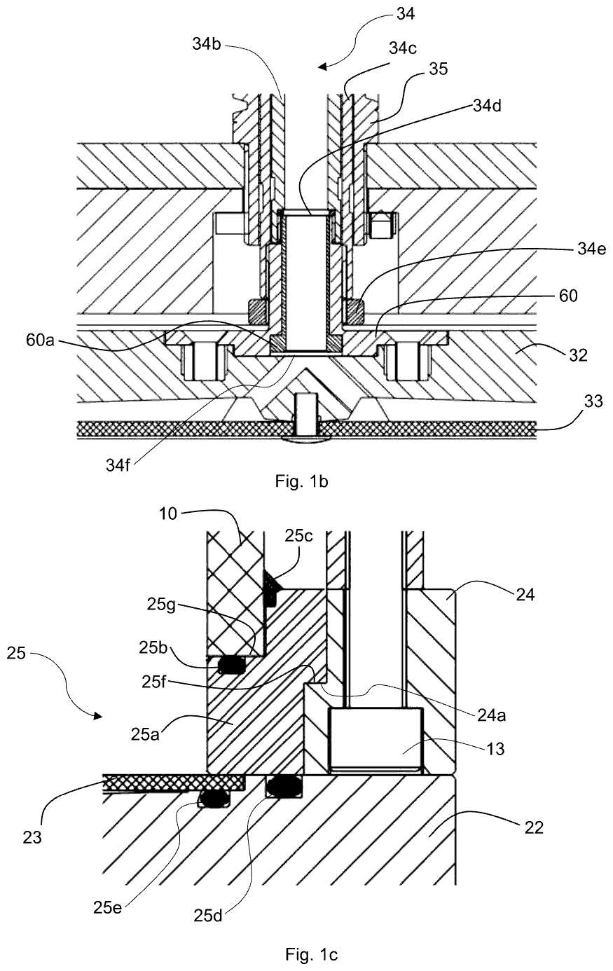

Referring to FIG. 1a there is illustrated a chromatography column 1 according to an embodiment of the invention. The column 1 comprises a column tube 10, a column base assembly 20 and a header assembly 30, which together define a process chamber 40 for receiving a process liquid, and an upper assembly 50. The column 1 is supported by a column stand 70.

The base assembly 20 comprises a bottom end plate 21, a lower flow cell 22, a lower bed support 23 and a base flange 24. The lower bed support 23 is secured in place by a bed support retaining bolt 23a. The base assembly 20 also comprises a flow cell inlet gasket 20a, a flow cell inlet adaptor 20b, a flow tube seal 20c, a blanking cap 20d and a clamp 20e, such as a sanitary pipework clamp, a click clamp or a tri clamp.

Positioned between the base flange 24 and the tube 10 is an interface assembly 25. In the illustrated embodiment, the interface assembly 25 comprises a barrier member 25a. The barrier member comprises a plastics material ring with a S-shaped cross-section or profile. FIG. 1c illustrates the barrier member 25a of FIG. 1a in more detail.

The S-shaped cross section of the barrier member 25a of the illustrated embodiment is defined by a wall comprising a stepped radially inwardly facing surface and a stepped radially outwardly facing surface, such that the lower section of the barrier member 25a has a smaller inner diameter than that of the upper section of the barrier member, and such that the lower section of the barrier member has a smaller outer diameter than that of the upper section of the barrier member. The upper portion of the stepped outwardly facing surface of the barrier member 25a of the illustrated embodiment provides an overhanging section with a lower surface 25f that engages with a corresponding upwardly facing surface 24a of a stepped radially inwardly facing surface of the base flange 24. This facilitates assembly and disassembly of the column as the barrier member 25a is held in place by engagement of the lower surface 25f of the barrier member 25a with the upper surface 24a of the base flange 24. Similarly, an upwardly facing surface 25g of the inwardly facing lower section of the barrier member supports the bottom of the tube 10. In the illustrated embodiment, the radially inwardly facing surface of the wall of the tube 10 has a diameter that is substantially equal to the diameter of the radially inwardly facing surface of the barrier member such that the radially inwardly facing surfaces are substantially flush in a vertical plane. This is preferred for fluid flow homogeneity and so as not to create dead space areas in the column 1.

While the barrier member 25a of the illustrated embodiment comprises an S-shaped cross-section, other suitable configurations of the barrier member 25a are envisaged so long as the interface assembly 25 prevents fluid from coming into contact with the base flange as described below. For example, rather than having an S-shaped cross-section, the barrier member may comprise a substantially U-shaped cross-section comprising a substantially vertical first wall and a substantially vertical second wall joined together by a substantially horizontal base wall. A lower edge of the tube 10 is positioned between the first wall and the second wall, such that the radially outwardly facing surface of the wall of the tube 10 engages with the first wall of the barrier member 25a, the radially inwardly facing surface of the wall of the tube 10 engages with the second wall and a lower edge of the wall of the tube 10 engages with an upwardly facing edge of the base wall of the barrier member. The first wall comprises a radially outward facing surface as described above, while the inner wall of the barrier may comprise a substantially flat radially inwardly facing wall.

The purpose of the interface assembly 25 is to allow a shield or barrier to be formed between the process chamber 40 and the base flange 24 of the base assembly 20. The interface assembly 25 may comprise a pressure and/or fluid-or liquid-impermeable seal. In order to improve the seal between the process chamber 40 and the base flange 24, the interface assembly 25 and/or other components of the column 1 may further comprise elastomeric sealing members, such as elastomeric sealing members 25b, 25c and 25d, which may form a continuous barrier between the process chamber 40 and the base flange 24. A further elastomeric sealing member 25e may be located between lower bed support 23 and the lower flow cell 22. The barrier member 25a, lower flow cell 22 or other portions of column 1 may be shaped to accommodate one or more of the elastomeric sealing members, for instance by including notches or grooves sized to accommodate the sealing members. Sealing member 25c may have an upper surface that declines as it extends away from the wall of the tube 10 for moving any liquid outside of the wall away from the seal area, which may occur when external cleaning of the column takes place. Sealing members 25c also aids in correct and central positioning of the tube 10. One of more of the elastomeric sealing members may comprise an O-ring. The base flange 24 comprises or consists of a metal such as stainless steel, which may be 316 stainless steel.

The upper assembly 50 is supported on the tube 10. An upper flange 51, the base flange 24 and tube support rods 12 (only one of which is illustrated) provide a compressive force to the flanges 51, 24 when bolts 13 are tightened at either end of the tube support rods 12. An upper end plate 53 and the bottom end plate 21 are secured to the upper flange 51 and the base flange 24, respectively, using bolts 52. Further elastomeric sealing members 51a and 51b are located at the upper end of the tube 10, between the tube 10 and the upper flange 51. Similarly to sealing member 25c, sealing member 51b may have an upper surface that declines as it extends away from the wall of the tube 10 for moving any liquid outside of the wall away from the seal area. Sealing members 51b also aids in correct and central positioning of the tube 10. The column 1 is supported in use by a support stand assembly 70.

The illustrated column 1 is an adjustable bed height design, meaning that the distance between the header assembly 30 and the base assembly 20 can be adjusted. In the illustrated embodiment, the header assembly 30 forms part of the adjustment assembly 3, which is used to adjust the height of the header assembly 30 relative to the base assembly 20. In other embodiments, the bed height may be fixed, in which case the header assembly 30 will be located at the upper end of the tube 10, adjacent or close to the upper end plate 53 and the column 1 will not comprise such an adjuster assembly 3. The header assembly 30 comprises a seal setting ring 31, an upper flow cell 32 and an upper bed support 33. The upper bed support 33 is secured by a bed support retaining bolt 33a and a bed support retaining ring 33b. An elastomeric sealing member 32a is located between the upper flow cell 32 and the tube 10.

The column 1 comprises a flow tube assembly 34 through which a liquid mobile phase may be introduced into the column 1. In the illustrated embodiment, the flow tube assembly 34 is housed within an externally-threaded adjustment cylinder 35, which forms part of the adjustment assembly 3. However, the skilled person will appreciate that in columns with a fixed bed height, alternative arrangements may be used. In the illustrated embodiment, the flow tube assembly 34 comprises a flow tube adaptor 34a, a flow tube 34b and a pipe 34c. The flow tube 34b is for conveying the liquid mobile phase to the upper flow cell 32 and is located inside the pipe 34c. The flow tube adaptor 34a and flow tube 34b preferably comprise a plastics material, and the pipe 34c may comprise a metal such as stainless steel. The flow tube assembly 34 also comprises a first flow tube seal 34d, a lock nut 34e, a flow cell inlet gasket 34f, a flow tube adaptor seal 34g, a blanking cap 34h, a clamp 34i and a second flow tube seal 34j.

The column 1 comprises, in use, an upper flow cell inlet adaptor 60, illustrated in more detail in FIG. 1b, for introducing the mobile phase into the process chamber 40 via the upper flow cell 32 and upper bed support 33.

The upper flow cell inlet adaptor 60 is in fluid communication with the flow tube 34b and is designed to be sufficiently strong to resist damage and distortion to the upper flow cell inlet adaptor 60 when the adjuster assembly 3 and column 1 are assembled and used and pressure is applied to the upper flow cell inlet adaptor 60. For this reason, the upper cell flow inlet 60 may be formed from a material such as a metal, which may be stainless steel. The locking nut 34e is a further example of a metal component. The column (and thus the refresh kit described below) may therefore be considered to comprise a plurality or mix of materials, i.e. some components may comprise and/or be formed from a material such as plastics material, while other parts may comprise and/or be formed from a material such as metal. Suitable plastics materials include polypropylene (PP), polyethylene (PE), polyvinylchloride (PVC), acrylonitrile butadiene styrene (ABS), nylon, polyether ether ketone (PEEK), polytetrafluoroethylene (PTFE) and acetal. In order to prevent any contact of the mobile phase or process liquid with the upper flow cell inlet adaptor 60, an inlet liner 60a, which may be substantially tubular, is inserted inside the upper flow cell inlet adaptor 60. The inlet liner 60a comprises plastics material, such as polypropylene.

When the column 1 is assembled for use, the flow tube adaptor 34a, the flow tube 34b and the inlet liner 60a form a continuous conduit through which the mobile phase may be delivered to the process chamber 40 without the mobile phase or the process liquid coming into contact with the pipe 34c or the upper flow cell inlet adaptor 60.

Once the column 1 has been used and it is necessary to remove any process-wetted components (i.e. those that have come into contact with the process liquid) and any other disposable and/or replaceable components, the column 1 may be disassembled. In the illustrated embodiment, the process-wetted components include the tube 10, the flow tube adaptor 34a, the flow tube 34b, the inlet liner 60a, the upper flow cell 32, the upper bed support 33, the interface assembly 25, the lower bed support 23 and the lower flow cell 22. Some or all of these components may be provided in a kit of parts (which is a combination or assembly of components) for refreshing the wetted pathway of a used chromatography column. Furthermore, the sealing members 25b, 25c, 25d, 25e, 32a, 51a and 51b may be included in the kit of parts. Others components that can be included in the kit of parts include the lower flow cell inlet gasket 20a, the lower flow cell inlet adaptor 20b, the lower flow tube seal 20c, the lower blanking cap 20d, the lower clamp 20e, the lower bed support retaining bolt 23a, the upper bed support retaining bolt 33a, the upper bed support retaining ring 33b, the lock nut 34e, the upper flow cell inlet gasket 34f, the upper flow tube seal 34g, the upper blanking cap 34h, the upper clamp 34i and the upper flow cell inlet 60.

The components that are intended to be removed and replaced may be disposable and/or recyclable. By disposable it is meant that the components are not designed to be used again after their intended use (which may be a particular production campaign or batch), and that it is economically viable to discard them after their intended use. By recyclable it is meant that the components are not designed to be used in their original form after their intended use, and that once the components have fulfilled their intended use, the material from which they are made can be industrially processed and reused to make a new product.

The adjuster assembly 3 can be removed from the other components of the column 1 by separating the upper plate 53 from the upper flange 51. The seal setting ring 31 and the upper flow cell 32 are separated from the adjuster assembly 3 so that the upper flow cell inlet 60 is accessible.

The upper flow tube adaptor 34a is separated from the flow tube 34b allowing the pipe 34c to be separated from the upper flow cell inlet adaptor 60. The flow tube 34b is separated from the upper flow cell adaptor 60. The upper flow cell adaptor 60 is separated from upper flow cell 32 giving access to the inlet liner. The inlet liner 60a is replaced with a new inlet liner 60a and a new elastomeric gasket 34f is fitted between the flow cell inlet 60 and a new upper flow cell 32. The replacement upper flow cell 32 has a new upper bed support 33 installed using new bed support bolt 33a and new bed supporting ring 33b. The flow tube seals 34d and 34j, the flow tube 34b and the flow tube adaptor 34a can then be replaced. The original pipe 34c is reused as it is not process wetted.

Once the adjuster assembly 3 has been removed, the upper flange 51 may be removed from the remaining components of the column 1 so that the tube 10 can be removed. The tube support rods 12 may be removed so that the interface assembly 25, base flange 24, lower bed support 23 and lower flow cell 22 can be removed. The base assembly 20 may then be reassembled by adding a new (replacement) lower flow cell 22 (into which new elastomeric seals 25d and 25e are fitted, and to which a new flow cell inlet gasket 20a, a new flow cell inlet adaptor 20b, a new flow tube seal 20c, a new blanking cap 20d and a new pipe clamp 20e are attached), a new lower bed support 23 (which is secured by bed support retaining bolt 23a), the original base flange 24 and tube support rods 12 (which have not been process wetted) and a new barrier member 25a (into which a new elastomeric seal 25b is fitted). A new tube 10 is located on the base assembly 20, and reassembly of the column 1 may be completed by reconnecting the upper flange 51 and the upper plate 53 and the adjuster assembly 3, the adjuster assembly 3 comprising a new flow tube adaptor 34a, a new flow tube 34b, a new inlet liner 60a, a new upper flow cell 32 and new elastomeric seal 32a.

In a some embodiments, each of the process-wetted parts comprises or consists of plastics material. However, it will be appreciated that the present invention seeks to provide a chromatography column 1 that can be refreshed or refurbished in an economically viable way. For this reason, it may be possible to use process-wetted components or other components that comprise materials other than plastics materials, or to use a combination of different materials for the process-wetted components, provided that they are economical to replace. For example, while the tube 10 may comprise plastics material such a transparent polymer material, which may be acrylic, glass may also be used. In a preferred embodiment, the upper flow cell inlet adaptor 60 is made from or comprises metal. The kit of parts may comprise parts that are not process-wetted in order to facilitate refreshing and refurbishing a chromatography column.

In each case, the materials should conform to industry standards. The invention provides a convenient and cost-effective way of refreshing and refurbishing a chromatography column.

1. A chromatography column comprising:
a column tube;
a column base assembly;
a column header assembly;
and an interface assembly;
wherein the tube, header assembly and base assembly define a process chamber for containing a process liquid;
the tube comprises an inner surface and an outer surface;
the column base assembly comprises a flow cell and an annular flange; and
the interface assembly is disposed between the flange and the outer surface of the tube and is arranged to create a fluid-impermeable barrier between the process chamber and the flange,
wherein the interface assembly comprises a material different from at least that of the flange.

2. A chromatography column according to any preceding claim wherein the interface assembly comprises an annular barrier member.

3. A chromatography column according to claim 2 wherein the barrier member comprises a plastics material, and optionally consists of a plastics material.

4. A chromatography column according to claim 2 or 3 wherein the barrier member comprises an S-shaped cross-section.

5. A chromatography column according to any preceding claim wherein the tube comprises plastics material or glass.

6. A chromatography column according to any preceding claim wherein the base assembly comprises a lower flow cell.

7. A chromatography column according to any preceding claim wherein the base assembly comprises a lower bed support.

8. A chromatography column according to any preceding claim wherein the flange comprises metal material, optionally stainless steel.

9. A chromatography column according to any preceding claim wherein the header assembly comprises an upper flow cell inlet adaptor for introducing a liquid into the process chamber an inlet liner for lining an inside surface of the upper flow cell inlet adaptor.

10. A chromatography column according to claim 9 wherein the inlet liner is removeable from the upper flow cell inlet adaptor.

11. A chromatography column according to claim 9 or claim 10 wherein the upper flow cell inlet adaptor comprises metal.

12. A chromatography column according to any of claims 9-11 wherein the inlet liner comprises plastics material, optionally polypropylene.

13. A chromatography column according to claim 12 wherein the inlet liner consists of plastics material.

14. A chromatography column according to any preceding claim wherein the column tube has external diameter in the range of 300-1600 mm, preferably 400-1200 mm, more preferably 450-900 mm and even more preferably 500-800 mm.

15. A chromatography column according to any preceding claim wherein the column tube comprises a wall thickness in the range of 5-30 mm, preferably 10-25 mm and more preferably 15-25 mm.

16. A kit of replacement parts for refurbishing a chromatography column wherein the column comprises, in its operational state, a column tube, a column base assembly, a column header assembly and an interface assembly, the tube, base assembly and header assembly defining a process chamber for containing a process liquid, the tube comprises an inner surface and an outer surface, the base assembly comprises a flow cell and an annular flange, the interface assembly is disposed between the flange and the outer surface of the tube and is arranged to create a fluid impermeable barrier between the process chamber and the flange, and an upper flow cell inlet adaptor for introducing a liquid into the process chamber and an inlet liner for lining an inside surface of the upper flow cell inlet adaptor, wherein the interface assembly comprises a material different from at least that of the flange,
wherein the kit of parts comprises:
an interface assembly, the interface assembly comprising a material different from at least that of the flange; and
an inlet liner for lining an inside surface of the upper flow cell inlet adaptor.

17. A kit of parts according to claim 16 wherein the interface assembly comprises a barrier member.

18. A kit of parts according to claim 17 wherein the barrier member comprises a plastics material and optionally consists of a plastics material.

19. A kit of parts according to claim 17 or 18 wherein the barrier member has an internal diameter in the range of 300-1600 mm, preferably 400-1200 mm, more preferably 450-900 and even more preferably 500-800 mm, and is substantially the same as the external diameter of the column tube, and the barrier member has an external diameter which is at least 55 mm greater than the external diameter of the column tube.

20. A kit of parts according to any of claims 17-19 wherein the inlet liner comprises a plastics material and optionally consists of a plastics material.

21. A kit of parts according to any of claims 17-20 further comprising a column tube, a flow tube adaptor, a flow tube, an upper flow cell, an upper flow cell inlet adaptor, an upper bed support, a lower bed support and a lower flow cell.

22. A kit of parts according to any of claims 17-21 further comprising at least one sealing member.

23. A kit of parts according to claim 22, wherein the at least one sealing member is an O-ring.

24. A kit of parts according to any of claims 17-23 further comprising a lower flow cell inlet gasket, a lower flow cell inlet adaptor, a lower flow tube seal, a lower blanking cap, a lower pipe clamp, a lower bed support retaining bolt, an upper bed support retaining bolt, a lock nut, an upper flow cell inlet gasket, a first upper flow tube seal, a second upper flow tube seal, an upper blanking cap, an upper pipe clamp and an upper flow cell inlet.

25. A kit of parts according to any of claims 17-24 wherein the components of the kit of parts are disposable and/or recyclable.
